(19) United States
(12) Patent Application Publication
(10) Pub. No.: US 2021/0218977 A1
(43) Pub. Date: Jul. 15, 2021

(54) METHODS AND SYSTEMS OF EXPONENTIAL PARTITIONING

(71) Applicant: OP Solutions, LLC, Amherst, MA (US)

(72) Inventors: Hari Kalva, Boca Raton, FL (US); Borivoje Furht, Boca Raton, FL (US)

(73) Assignee: OP Solutions, LLC, Amherst, MA (US)

(21) Appl. No.: 17/220,028

(22) Filed: Apr. 1, 2021

Related U.S. Application Data
(63) Continuation of application No. PCT/US19/54069, filed on Oct. 1, 2019.
(60) Provisional application No. 62/739,446, filed on Oct. 1, 2018.
(60) Provisional application No. 62/739,677, filed on Oct. 1, 2018.
(60) Provisional application No. 62/739,531, filed on Oct. 1, 2018.

(51) Int. Cl. H04N 19/44; H04N 19/91; H04N 19/124; H04N 19/61; H04N 19/169

(52) U.S. Cl. CPC H04N 19/44; H04N 19/91; H04N 19/1883; H04N 19/619; H04N 19/124

(57) ABSTRACT

A decoder includes a circuitry configured to receive a bitstream, determine whether an exponential partitioning mode is enabled, partition a block into a first region and a second region according to a curved line, and reconstruct pixel data of the block and using the curved line, the first region and the second region being non-rectangular.

### CROSS-REFERENCE TO RELATED APPLICATIONS

This application is a continuation of International Application Serial No. PCT/US2019/054069, filed on Oct. 1, 2019 and entitled “METHODS AND SYSTEMS OF EXPONENTIAL PARTITIONING,” which claims the benefit of priority to U.S. Provisional Applications Ser. Nos. 62/739,446, filed on Oct. 1, 2018 and entitled “EXPONENTIAL PARTITIONING”; 62/739,677, filed on Oct. 1, 2018 and entitled “PREDICTING EXPONENTIAL PARTITIONING PARAMETERS”; and 62/739,531, filed on Oct. 1, 2018 and entitled “SHAPE ADAPTIVE DISCRETE COSINE TRANSFORMATION FOR EXPONENTIALLY PARTITIONED BLOCKS”, which are each incorporated by reference herein in their entirety.

### FIELD OF THE INVENTION

The present invention relates generally to the field of technologies to compress and decompress digital video, including decoding and encoding. In particular, the present invention is directed to method and systems for exponential partitioning of coding units.

### BACKGROUND

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

A format of the compressed data can conform to a standard video compression specification. The compression can be lossy in that the compressed video lacks some information present in the original video. A consequence of this can include that decompressed video can have a lower quality than the original uncompressed video because there is insufficient information to accurately reconstruct the original video.

There can be complex relationships between the video quality, the amount of data used to represent the video (e.g., determined by the bit rate), the complexity of the encoding and decoding algorithms, sensitivity to data losses and errors, ease of editing, random access, end-to-end delay (e.g., latency), and the like.

### SUMMARY OF THE DISCLOSURE

In an aspect a decoder includes circuitry configured to receive a bitstream including a coded picture, identify a non-straight, non-rectangular boundary in the coded picture, the non-straight, non-rectangular boundary having a first side and a second side, generate a first predictor for use on the first side, generate a second predictor for use on the second side, smooth the first predictor and the second predictor across the non-straight, non-rectangular boundary, add residual pixel values to each of the first predictor and the second predictor, and decode the coded picture using the first predictor, the second predictor, and the residual pixel values.

In another aspect a method includes receiving, by a decoder, a bitstream including a coded picture, identifying, by the decoder, a non-straight, non-rectangular boundary in the coded picture, the non-straight, non-rectangular boundary having a first side and a second side, generating, by the decoder, a first predictor for use on the first side, generating, by the decoder, a second predictor for use on the second side, smoothing, by the decoder, the first predictor and the second predictor across the non-straight, non-rectangular boundary, adding, by the decoder, residual pixel values to each of the first predictor and the second predictor, and decoding, by the decoder, the coded picture using the first predictor, the second predictor, and the residual pixel values.

In another aspect of the invention, a decoder can include circuity that may be configured to receive a bitstream. In an embodiment, the circuity can further be configured to determine whether an exponential partitioning mode is enabled and to partition a block into a first region and a second region according to a curved line. In an embodiment, the circuitry can also be configured to reconstruct pixel data of the block using the curved line where the first region and the second region may be non-rectangular.

The decoder can further include one or more of the following features taken alone or in combination. In an embodiment, the exponential partitioning mode can be signaled in the bitstream. In an embodiment, the curved line partitioning the block into the first region and the second region may be characterized by a predefined template. In another embodiment, the curved line partitioning the block into the first region and the second region can be characterized by a predefined coefficient value. Further, in an embodiment, the exponential partitioning mode is available for block sizes greater or equal to 8×8 luma samples. In another embodiment, reconstructing pixel data can include computing a predictor for the first region using an associated motion vector contained in the bitstream. In another embodiment, the decoder can also include an entropy decoder processor that can be configured to receive the bitstream and decode the bitstream into quantized coefficients. The decoder can also include an inverse quantization and inverse transformation processor that can be configured to process the quantized coefficients including performing an inverse discrete cosine transform. Further, the decoder can include a deblocking filter, a frame buffer; and an intra prediction processor. In an embodiment, the bitstream can include a parameter indicating whether the exponential partitioning mode is enabled for the block. In another embodiment, the block may form part of a quadtree plus binary decision tree. Also, the block can be a non-leaf node of the quadtree plus binary decision tree. In an embodiment, the block can be a coding tree unit or a coding unit. In another embodiment, the first region can be a coding unit or a prediction unit.

In a further aspect of the invention, a method can include receiving, by a decoder, a bit stream and determining, by said decoder, whether an exponential partitioning mode is enabled. The method can also include determining, by the decoder, a curved line partitioning a block into a first region and a second region and also reconstructing, by the decoder, pixel data of the block and using the curved line.

The method can further include one or more of the following features taken alone or in combination. In an embodiment, the exponential partitioning mode can be signaled in the bitstream. In another embodiment, the curved line partitioning the block into the first region and the second region may be characterized by a predefined template. In an embodiment, the curved line partitioning the block into the first region and the second region can be characterized by a predefined coefficient value. In an embodiment, the exponential partitioning mode can be available for block sizes greater or equal to 8×8 luma samples. In another embodiment, reconstructing pixel data can include computing a predictor for the first region using an associated motion vector contained in the bitstream. In another embodiment, the decoder can include an entropy decoder processor that may be configured to receive the bitstream and decode the bitstream into quantized coefficients. The decoder can also include an inverse quantization and inverse transformation processor that can be configured to process the quantized coefficients including performing an inverse discrete cosine transform. Further, the decode can encompass a deblocking filter, a frame buffer, and an intra prediction processor. In an embodiment, the bitstream can include a parameter indicating whether the exponential partitioning mode is enabled for the block. In another embodiment, the block can form part of a quadtree plus binary decision tree. Also, the block can be a non-leaf node of the quadtree plus binary decision tree. In another embodiment, the block can be a coding tree unit or a coding unit. In an embodiment, the first region may be a coding unit or a prediction unit.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

FIG. 1 is a diagram illustrating an example of block partitioning of pixels;

FIG. 2 is a diagram illustrating an example of geometric partitioning;

FIG. 3A is a diagram illustrating an example of exponential partitioning according to some aspects of the current subject matter, which can increase compression efficiency;

FIG. 3B is a series of diagrams illustrating example template exponential partitions;

FIG. 3C illustrates example curves associated with 4 predefined coefficients, which can define an example exponential function;

FIG. 3D illustrates another example block showing different starting P₁ and ending P₂ indices that partition the rectangular block;

FIG. 4 is a system block diagram illustrating an example video encoder capable of performing exponential partitioning;

FIG. 5A is a process flow diagram illustrating an example process of encoding a video with exponential partitioning according to some aspects of the current subject matter that can reduce encoding complexity while increasing compression efficiency;

FIG. 5B is a process flow diagram illustrating an example process of encoding a video with exponential partitioning using partitioning parameters according to some aspects of the current subject matter;

FIG. 5C is a process flow diagram illustrating an example process of encoding a video with exponential partitioning using shape adaptive discrete cosine transformation according to some aspects of the current subject matter;

FIG. 6 is a system block diagram illustrating an example decoder capable of decoding a bitstream using exponential partitioning;

FIG. 7 is a process flow diagram illustrating an example process of decoding a bit stream using exponential partitioning;

FIG. 8 illustrates an example of quad-tree plus binary tree partitioning of a frame;

FIG. 9 illustrates an example of exponential partitioning at the CU level of the quad-tree plus binary tree illustrated in FIG. 8;

FIG. 10 illustrates an image containing an apple that may not be efficiently partitioned by straight line segments;

FIG. 11 is a diagram illustrating another example block partitioned according to exponential partitioning.

FIG. 12 is a diagram illustrating inheritance of exponential partitioning parameters by a current block from a spatially adjacent block;

FIG. 13 illustrates examples of spatially adjacent blocks for a current block; and

FIG. 14 illustrates an example current block with a temporally adjacent block from which the current block inherits exponential partitioning parameters.

Like reference symbols in the various drawings indicate like elements.

### DETAILED DESCRIPTION

Some implementations of the current subject matter relate to exponential partitioning. In exponential partitioning, a rectangular block can be partitioned into non-rectangular regions with a curve as compared to a straight-line segment. Using a curve to partition blocks can allow partitioning to more closely follow object boundaries, resulting in lower motion compensation prediction error, smaller residuals, and thus improved compression efficiency. In some implementations, the curve can be characterized by an exponential function. The curve (e.g., exponential function) can be determined using predefined coefficients and/or templates, which can be signaled in the bitstream for use by the decoder. In some implementations, exponential partitioning can be available for greater than or equal to 8×8 luma samples. By partitioning rectangular blocks with a curve, greater compression efficiency can be achieved for certain objects than techniques limited to straight line segment partitions, such as with geometric partitioning.

Also, some implementations of the current subject matter relate to predicting exponential partitioning parameters using spatial and/or temporal reference blocks. In some implementations, for a given current block, an exponential partitioning merge variable can be signaled indicating that a given current block can inherit all or some of these exponential partitioning parameters from another block. This other block can be spatially or temporally adjacent. By allowing blocks to inherit exponential partitioning parameters from other blocks, the amount of signaling within the bitstream can be reduced, which can achieve greater compression efficiency.

Further, some implementations of the current subject matter can include performing a shape adaptive discrete cosine transformation (SADCT) on regions (e.g., blocks) that have been partitioned into non-rectangular regions with a curve as compared to a straight-line segment. Where a block is exponentially partitioned, it is likely that the resulting regions (e.g., partitions) will result in one region having low prediction error, and another region having high prediction error. Accordingly, the current subject matter can include performing the SADCT for the region having low prediction error. By performing the SADCT for the region having low prediction error, compression efficiency can be improved. And in some implementations, during decoding, inverse SADCT can be performed for one region partitioned by exponential partitioning. In some implementations, inverse SADCT can be signaled in the bitstream as an additional transform choice to the full block discrete cosine transformation (DCT) for the segment with low prediction error. In some implementations, inverse SADCT can be performed based on exponential partitioning parameters and without having to explicitly signal in the bitstream that an inverse SADCT is to be performed.

Motion compensation can include an approach to predict a video frame or a portion thereof given the previous and/or future frames by accounting for motion of the camera and/or objects in the video. It can be employed in the encoding and decoding of video data for video compression, for example in the encoding and decoding using the Motion Picture Experts Group (MPEG)-2 (also referred to as advanced video coding (AVC)) standard. Motion compensation can describe a picture in terms of the transformation of a reference picture to the current picture. The reference picture can be previous in time or from the future when compared to the current picture. When images can be accurately synthesized from previously transmitted and/or stored images, the compression efficiency can be improved.

Block partitioning can refer to a method in video coding to find regions of similar motion. Some form of block partitioning can be found in video codec standards including MPEG-2, H.264 (also referred to as AVC or MPEG-4 Part 10), and H.265 (also referred to as High Efficiency Video Coding (HEVC)). In example block partitioning approaches, non-overlapping blocks of a video frame can be partitioned into rectangular sub-blocks to find block partitions that contain pixels with similar motion. This approach can work well when all pixels of a block partition have similar motion. Motion of pixels in a block can be determined relative to previously coded frames.

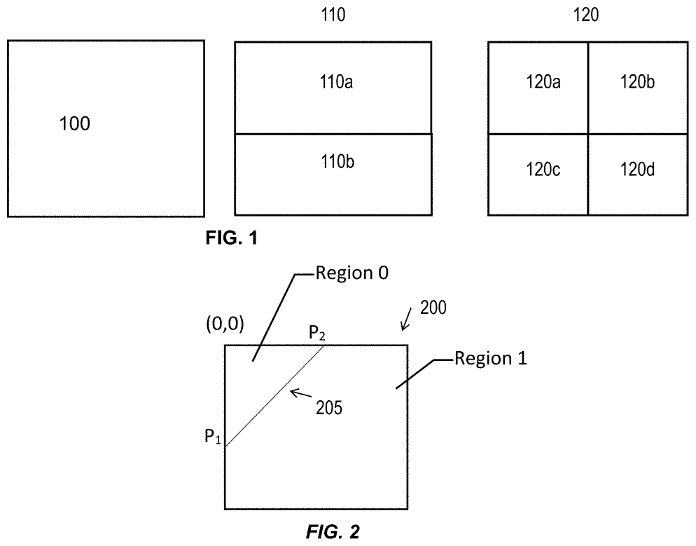

FIG. 1 is a diagram illustrating an example of block partitioning of pixels, according to an embodiment. An initial rectangular picture or block 100, which may itself be a sub-block (e.g., a node within a coding tree), can be partitioned into rectangular sub-blocks. For example, at 110, block 100 is partitioned into two rectangular sub-blocks 110a and 110b. Sub-blocks 110a and 110b can then be processed separately. As another example, at 120, block 100 is partitioned into four rectangular sub-blocks 120a, 120b, 120c, and 120d. Sub-blocks may themselves be further divided until it is determined that the pixels within the sub-blocks share the same motion, a minimum block size is reached, or other criteria. When pixels in a sub-block have similar motion, a motion vector can describe the motion of all pixels in that region.

Some approaches to video coding can include geometric partitioning in which a rectangular block (e.g., as illustrated in FIG. 1) is further divided by a straight-line segment into two regions that may be non-rectangular. For example, FIG. 2 is a diagram illustrating an example of geometric partitioning. An example rectangular block 200 (which can have a width of M pixels and a height of N pixels, denoted as M×N pixels) can be divided along a straight-line segment P1P2 205 into two regions (region 0 and region 1). When pixels in region 0 have similar motion, a motion vector can describe the motion of all pixels in that region. The motion vector can be used to compress region 0. Similarly, when pixels in region 1 have similar motion, an associated motion vector can describe the motion of pixels in region 1. Such a geometric partition can be signaled to the receiver (e.g., decoder) by encoding positions P1 and P2 (or representations of positions P1 and P2) in the video bitstream.

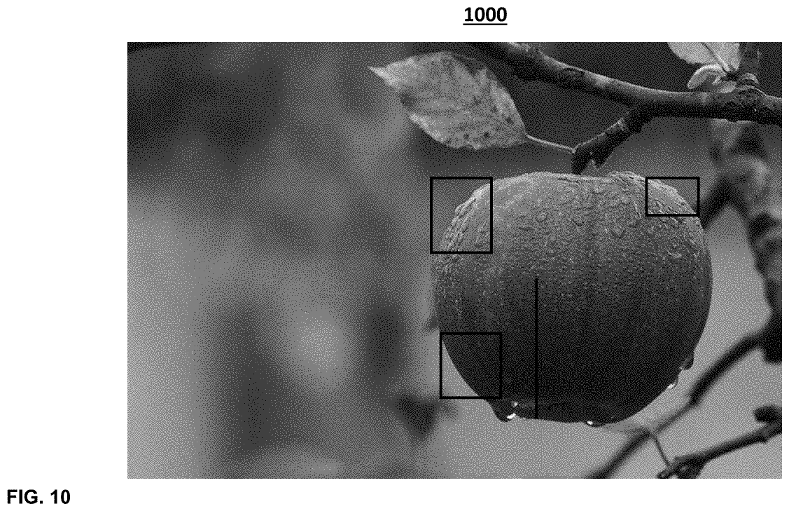

When encoding video data utilizing geometric partitioning, straight line segment 205 (or more specifically points P1 and P2) can be determined. But a straight-line segment may not be capable of partitioning the block in a manner that reflects object boundaries. As a result, partitioning with straight line segments may not be capable of partitioning a block in an efficient manner (e.g., such that any resulting residual is small). This can be true where the block may contain pixels (e.g., luma samples) representing an object or boundary having a curved (e.g., non-straight) boundary. For example, referring now to FIG. 10, an image containing an apple that may not be efficiently partitioned by straight line segments is presented. The apple includes several rectangular blocks indicating portions of the image which, if partitioned using a straight-line segment according to geometric partitioning, the partitioning may not closely follow the object (e.g., apple) boundary.

Some implementations of the current subject matter include partitioning a rectangular block into non-rectangular regions with a curve as compared to a straight-line segment. Using a curve to partition blocks can allow partitions to more closely follow object boundaries, resulting in lower prediction error, smaller residuals, and thus improved compression efficiency. In some implementations, the curve can be characterized by an exponential function. The curve (e.g., exponential function) can be represented using predefined coefficients and/or indices, which can be signaled in the bitstream for use by the decoder. In some implementations, exponential partitioning can be available for blocks with greater than or equal to 8×8 luma samples. By partitioning rectangular blocks with a curve, the current subject matter can achieve greater compression efficiency for certain objects than techniques limited to straight line segment partitions, such as with geometric partitioning.

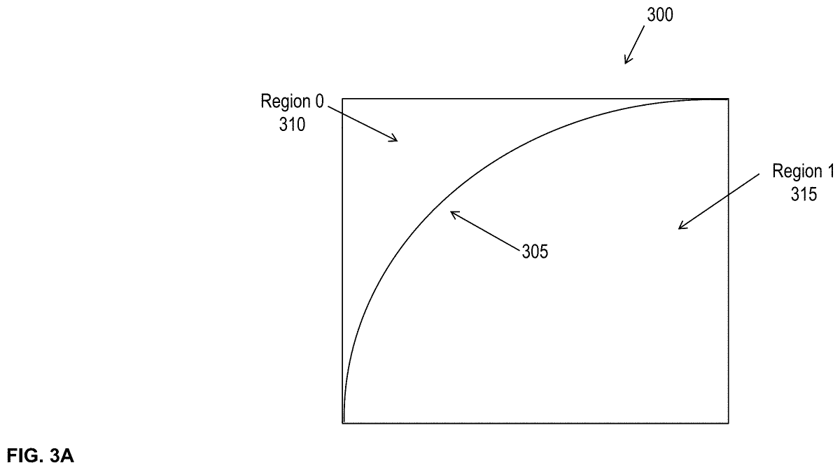

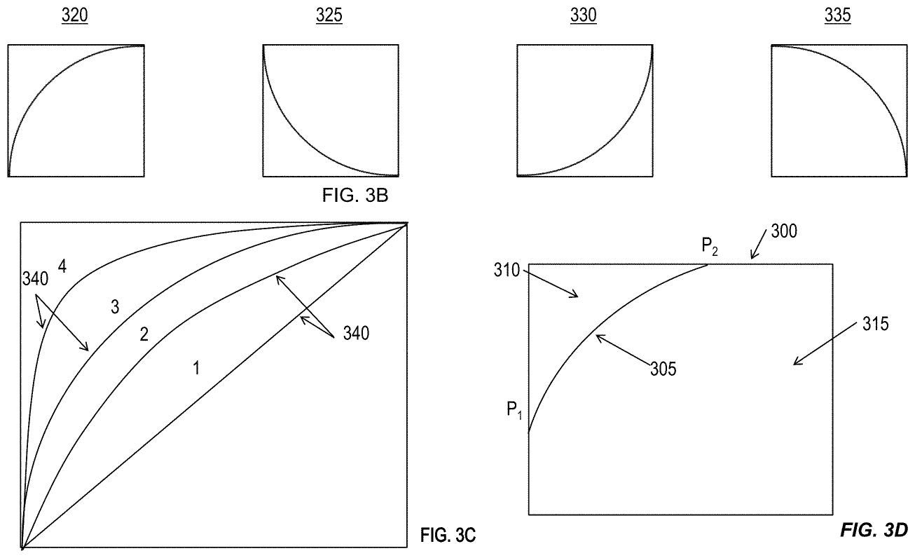

FIG. 3A is a diagram illustrating an example of exponential partitioning according to some aspects of the current subject matter, which can increase compression efficiency. Rectangular block 300 includes pixels (e.g., luma samples). The rectangular block 300 can have, for example, a size of 8×8 pixels (e.g., luma samples), or greater.

In FIG. 3A, rectangular block 300 can be partitioned into two regions (e.g., region 0 and region 1, denoted by 310 and 315, respectively) by curved line 305. All luma samples within region 310 can be considered to have the same or similar motion and can be represented by the same motion vector. Similarly, all luma samples within region 315 can be considered to have the same or similar motion and can be represented by the same motion vector. In some implementations, all luma samples to the left or above the curved line segment 305 dividing the rectangular block 300 can be considered to belong to region 0 (310). In some implementations, all luma samples to the right or below the curved line segment 305 dividing the rectangular block 300 can be considered to belong to region 1 (315). In some implementations, all luma samples through which the curved line segment dividing the rectangular block 300 belong to region 0 (310). In some implementations, all luma samples through which the curved line segment dividing the rectangular block 300 can be considered to belong to region 1 (315). Other implementations can be possible.

In some implementations, by performing exponential partitioning, the number of possible partitions that can occur can be reduced (e.g., as compared to geometric partitioning), which can reduce the computational requirement of evaluating motion estimation to identify the appropriate partition (e.g., to identify the best line segment to partition a block). In some implementations, by performing exponential partitioning, non-rectangular regions (e.g., 310 and 315) can more closely follow object boundaries, thereby reducing prediction error, residual size, and increasing compression efficiency as compared to encoding video using geometric partitioning.

Exponential partitioning can be represented in the bit stream. In some implementations, an exponential partitioning mode can be utilized, and appropriate parameters can be signaled in the bitstream. For example, exponential partitioning can be represented in the bit stream by signaling predetermined exponential partitioning templates. FIG. 3B is a series of diagrams illustrating example template partitions, according to an embodiment. These regular exponential partitions can specify a set of predetermined orientations. In some implementations, signaling can be performed by including an index to one or more of these regular (e.g., template) exponential partitions that are predefined. For example, FIG. 3C illustrates example curves associated with 4 predefined templates (1,2,3,4), according to an embodiment. The number of template curvatures can vary in some implementations.

As another example, exponential partitions can be represented in the bit stream by signaling predetermined coefficients that indicate the degree of curvature, which can allow for additional exponential functions.

In some implementations, a predefined template used in an exponential partitioning mode can indicate a straight-line segment. For example, in FIG. 3C, the segment indexed by coefficient 1 is a straight line, which can be considered a special case of exponential partitioning and can result in an outcome similar to that of geometric partitioning.

In some implementations, both orientation templates, an example of which is illustrated in FIG. 3B, and predefined templates, an example of which is illustrated in FIG. 3C, can be utilized to efficiently signal a large number of potential exponential partitions.

In some implementations, starting and ending indices can be predetermined. For example, FIG. 3A illustrates a curved line segment starting at the lower left-hand corner of the rectangular block 300 and ending at the upper right-hand corner of rectangular block 300 according to an embodiment. In some implementations, starting and ending indices can be explicitly signaled in the bitstream. For example, FIG. 3D illustrates another example block showing different starting P1 and ending P2 indices that partition the rectangular block 300. The starting P1 and ending P2 indices can be signaled directly or can be indicated by an index into a set of predetermined values. In some embodiments other parameters are possible.

In some implementations, exponential partitioning parameters need not be included in the bitstream for each block undergoing exponential partitioning (e.g., for which exponential partitioning mode is true). For example, for a given current block, exponential partitioning parameters can be inherited from another block (sometimes referred to as the parent block). The parent block can be spatially and/or temporally adjacent. The parent block can be indicated in the bitstream by an index to a predetermined list and/or can be indicated by at least constructing a candidate list, to which an index is signaled in the bitstream.

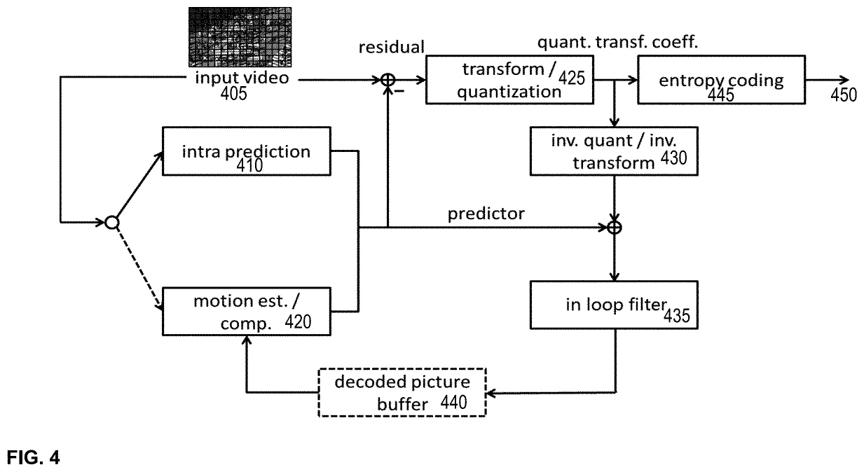

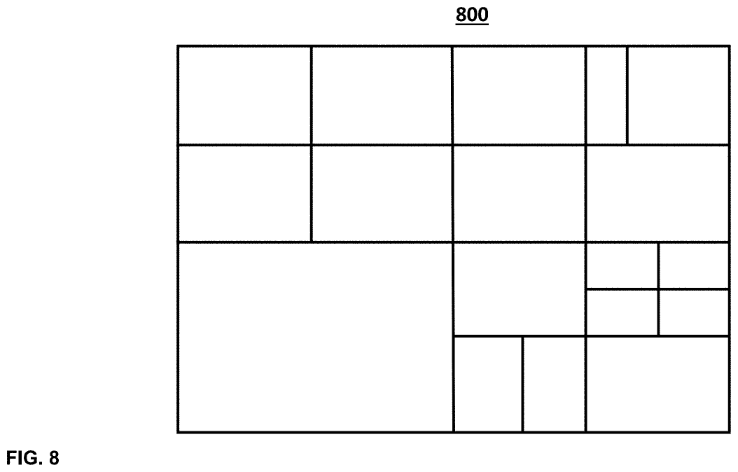

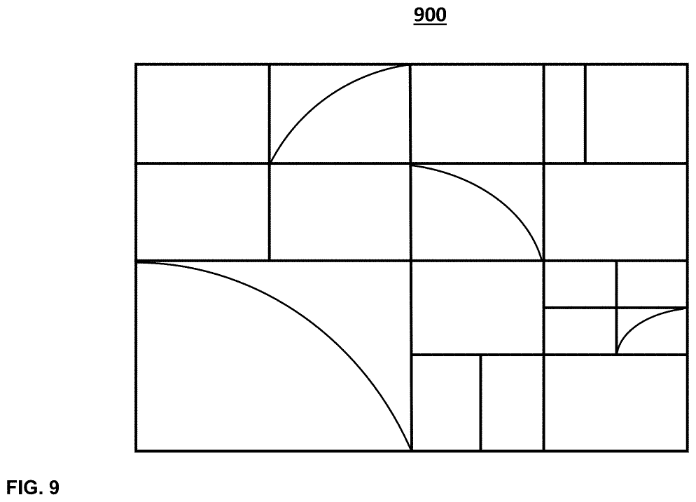

FIG. 4 is a system block diagram illustrating an example embodiment of video encoder 400 capable of performing exponential partitioning, such as with SADCT. The example video encoder 400 receives an input video 405, which can be initially segmented or dividing according to a processing scheme, such as a tree-structured macro block partitioning scheme (e.g., quad-tree plus binary tree (QTBT)). An example of a tree-structured macro block partitioning scheme can include partitioning a picture frame into large block elements called coding tree units (CTU). In some implementations, each CTU can be further partitioned one or more times into a plurality of sub-blocks called coding units (CU). The result of this portioning can include a group of sub-blocks that can be called predictive units (PU). Transform units (TU) can also be utilized. Such a partitioning scheme can include performing exponential partitioning according to some aspects of the current subject matter. For example, FIG. 8 illustrates an example of QTBT partitioning of a frame, and FIG. 9 illustrates an example of exponential partitioning at the CU level of the QTBT illustrated in FIG. 8.

The example video encoder 400 includes an intra prediction processor 415, a motion estimation/compensation processor 420 (also referred to as an inter prediction processor) capable of supporting exponential partitioning, a transform/quantization processor 425, an inverse quantization/inverse transform processor 430, an in-loop filter 435, a decoded picture buffer 440, and an entropy coding processor 445. In some implementations, the motion estimation/compensation processor 420 can perform exponential partitioning including determining whether a current block can inherit exponential partitioning parameters from another block and which block from which to inherit. In some implementations, transform/quantization processor 425 can perform SADCT. Bitstream parameters that signal exponential partitioning modes and inheritance can be input to the entropy coding processor 445 for inclusion in the output bit stream 450.

In operation, for each block of a frame of the input video 405, whether to process the block via intra picture prediction or using motion estimation/compensation can be determined. The block can be provided to the intra prediction processor 410 or the motion estimation/compensation processor 420. If the block is to be processed via intra prediction, the intra prediction processor 410 can perform the processing to output the predictor. If the block is to be processed via motion estimation/compensation, the motion estimation/compensation processor 420 can perform the processing including use of exponential partitioning to output the predictor.

A residual can be formed by subtracting the predictor from the input video. The residual can be received by the transform/quantization processor 425, which can perform transformation processing (e.g., SADCT) to produce coefficients, which can be quantized. The quantized coefficients and any associated signaling information can be provided to the entropy coding processor 445 for entropy encoding and inclusion in the output bit stream 450. The entropy encoding processor 445 can support encoding of signaling information related to exponential partitioning. In addition, the quantized coefficients can be provided to the inverse quantization/inverse transformation processor 430, which can reproduce pixels, which can be combined with the predictor and processed by the in-loop filter 435, the output of which is stored in the decoded picture buffer 440 for use by the motion estimation/compensation processor 420 that is capable of supporting exponential partitioning.

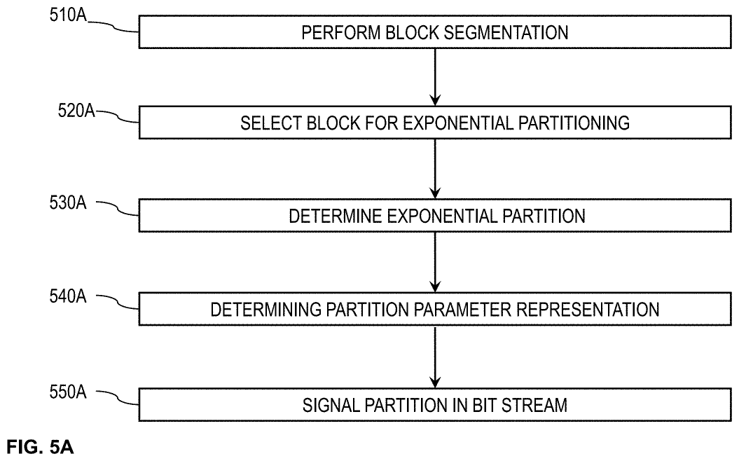

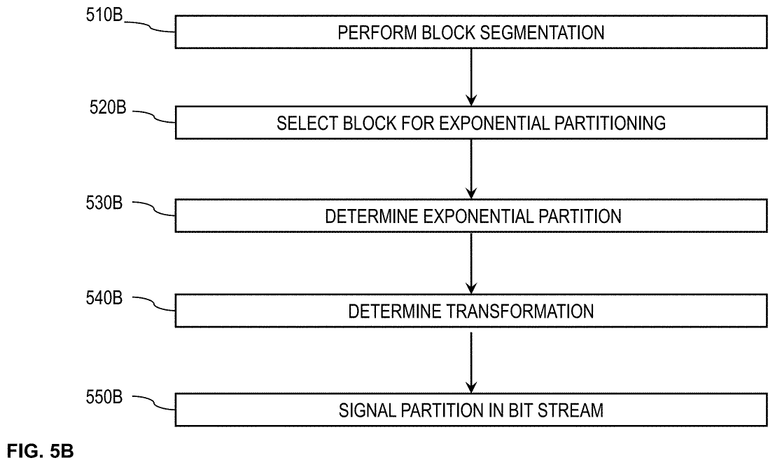

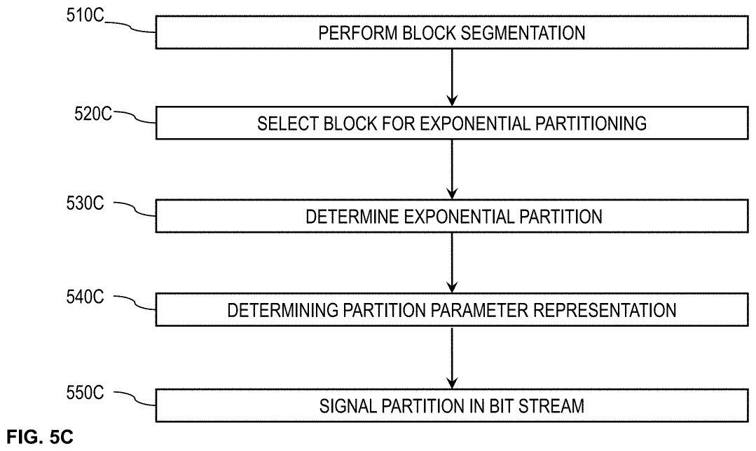

FIG. 5A is a process flow diagram illustrating an example process 500A of encoding a video with exponential partitioning according to some aspects of the current subject matter that can reduce encoding complexity while increasing compression efficiency. At 510A, a video frame can undergo initial block segmentation, for example, using a tree-structured macro block partitioning scheme that can include partitioning a picture frame into CTUs and CUs. At 520, a block can be selected for exponential partitioning. The selection can include identifying according to a metric rule that the block is to be processed according to an exponential partitioning mode.

At 530A, an exponential partition can be determined. A curved line (e.g., 305) can be determined that will separate the pixels contained within the block according to their inter frame motion into two non-rectangular regions (e.g., region 0 and region 1) such that pixels (e.g., luma samples) within one of the regions (e.g., region 0) have similar motion and pixels within the other region (e.g., region 1) have similar motion. At 550A, the determined exponential partition can be signaled in the bit stream. Signaling in the bitstream can include, for example, including an index into one or more predetermined templates and/or coefficients.

FIG. 5B is a process flow diagram illustrating an example process 500B of encoding a video with exponential partitioning according to some aspects of the current subject matter that can reduce encoding complexity while increasing compression efficiency. At 510B, a video frame can undergo initial block segmentation, for example, using a tree-structured macro block partitioning scheme that can include partitioning a picture frame into CTUs and CUs. At 520B, a block can be selected for exponential partitioning. The selection can include identifying according to a metric rule that the block is to be processed according to an exponential partitioning mode.

At 530B, an exponential partition can be determined. A curved line (e.g., 305) can be determined that will separate the pixels contained within the block according to their inter frame motion into two non-rectangular regions (e.g., region 0 and region 1) such that pixels (e.g., luma samples) within one of the regions (e.g., region 0) have similar motion and pixels within the other region (e.g., region 1) have similar motion.

At 540B, partitioning parameter representation can be determined, which can include determining whether a current block inherits exponential partitioning parameters from another block and which other block the current block will inherit from.

At 550B, the determined exponential partition can be signaled in the bit stream. Signaling in the bitstream can include, for example, including an index into a predetermined list of spatial and temporally adjacent blocks.

FIG. 5C is a process flow diagram illustrating an example process 500C of encoding a video with exponential partitioning and SADCT according to some aspects of the current subject matter that can reduce encoding complexity while increasing compression efficiency. At 510C, a video frame can undergo initial block segmentation, for example, using a tree-structured macro block partitioning scheme that can include partitioning a picture frame into CTUs and CUs. At 520C, a block can be selected for exponential partitioning. The selection can include identifying according to a metric rule that the block is to be processed according to an exponential partitioning mode.

At 530C, an exponential partition can be determined. A curved line (e.g., 305) can be determined that will separate the pixels contained within the block according to their inter frame motion into two non-rectangular regions (e.g., region 0 and region 1) such that pixels (e.g., luma samples) within one of the regions (e.g., region 0) have similar motion and pixels within the other region (e.g., region 1) have similar motion. At 540C, an appropriate transformation can be determined for one or more of region 0 and region 1. For example, whether region 0 or region 1 has low prediction error can be determined. In response to determining that region 0 has low prediction error, region 0 can be encoded using a SADCT. In response to determining that region 1 has low prediction error, region 1 can be encoded using SADCT. In some implementations, a region can be considered to have low prediction error when a prediction error is below a predetermined threshold.

At 550C, the determined exponential partition and transformation choice can be signaled in the bit stream. Signaling in the bitstream can include, for example, including an index into one or more predetermined templates and/or coefficients. Signaling in the bitstream can include, for example, signaling SADCT as an additional transform choice to full block DCT for the region (e.g., region 0 or region 1) that has low prediction error.

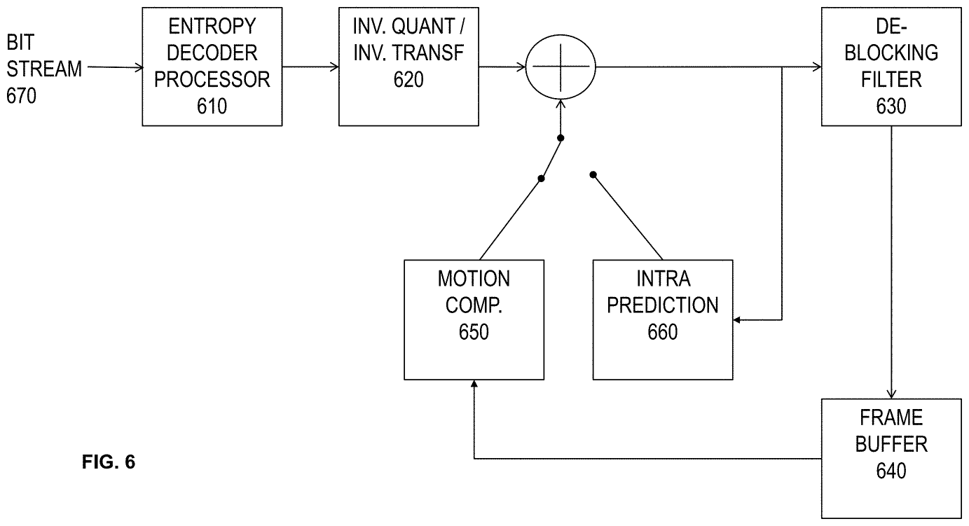

FIG. 6 is a system block diagram illustrating an example decoder 600 capable of decoding a bitstream 670 using exponential partitioning and/or inverse SADCT. The decoder 600 includes an entropy decoder processor 610, an inverse quantization and inverse transformation processor 620, a deblocking filter 630, a frame buffer 640, motion compensation processor 650 and intra prediction processor 660. In some implementations, the bitstream 670 includes parameters that signal an exponential partitioning mode. In some implementations, the bitstream 670 includes parameters that signal the type of inverse transformation to apply (e.g., inverse block DCT or inverse SADCT). The motion compensation processor 650 can reconstruct pixel information using exponential partitioning and/or inverse SADCT as described herein.

In operation, bitstream 670 can be received by the decoder 600 and input to entropy decoder processor 610, which entropy decodes the bit stream into quantized coefficients. The quantized coefficients can be provided to inverse quantization and inverse transformation processor 620, which can perform inverse quantization and inverse transformation utilizing inverse SADCT and according to the signals in the bitstream. The inverse transformation can create a residual signal, which can be added to the output of motion compensation processor 650 or intra prediction processor 660 according to the processing mode. The output of the motion compensation processor 650 and intra prediction processor 660 can include a block prediction based on a previously decoded block. The sum of the prediction and residual can be processed by deblocking filter 630 and stored in a frame buffer 640. For a given block, (e.g., CU or PU), when the bit stream 670 signals that the partitioning mode is exponential partitioning, motion compensation processor 650 can construct the prediction based on the exponential partitioning scheme described herein including, for a current block, extracting from the bitstream an index into a predetermined list of spatial and temporally adjacent blocks, and using exponential partitioning parameters for the indicated block to reconstruct a current block.

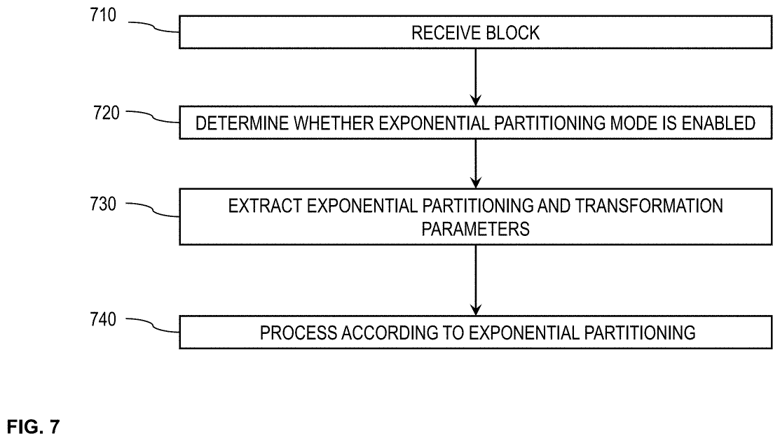

FIG. 7 is a process flow diagram illustrating an example process 700 of decoding a bit stream using exponential partitioning, which, in some implementations, may use inverse SADCT. At 710, a block (e.g., CTU, CU, PU) is received. Receiving can include extracting and/or parsing the block and associated signaling information from the bit stream. At 720, whether exponential partitioning mode is enabled (e.g., true) for the block can be determined. If the exponential partitioning mode is not enabled (e.g., false), the decoder can process the block using an alternative partitioning mode such as geometric partitioning. If the exponential partitioning mode is enabled (e.g., true), at 730, the decoder can extract and/or determine one or more parameters that characterize the exponential partitioning and transformation. These parameters can include, for example, exponential coefficient indices, exponential coefficient values, orientation template indices, and/or the indices of the start and end of the curved line (e.g., P1P2). Extraction parameters can include identifying and retrieving the parameters from the bit stream (e.g., parsing the bitstream). Said parameters can include transformation parameters, for example, that can indicate whether to process a block using inverse SADCT. Further, determining of one or more parameters that characterize the exponential partitioning can include determining that an exponential partitioning merge has been signaled and using an index contained in the bitstream, determine an adjacent block from which a current block inherits exponential partitioning parameters. At 740, the block can be processed according to exponential partitioning (e.g., to produce a prediction), including determining the associated motion information for each region. In some implementations, at 740, the block can be further processed utilizing inverse SADCT.

Although a few variations have been described in detail above, other modifications or additions are possible. For example, in some implementations, exponential partitioning can apply to symmetric blocks (8×8, 16×16, 32×32, 64×64, 128×128, and the like) as well as various asymmetric blocks (8×4, 16×8, and the like).

In some implementations, spatial and temporal exponential parameter prediction can be performed for a luma block size of 16×16 or larger, such as 64×64 and/or 128×128. In some implementations, a minimum block size of 16×16 can be imposed.

The partitioning can be signaled in the bit stream based on rate-distortion decisions in the encoder. The coding can be based on a combination of regular pre-defined partitions (e.g., templates), temporal and spatial prediction of the partitioning, and additional offsets. Each exponential partitioned region can utilize motion compensated prediction or intra-prediction. The boundary of the predicted regions can be smoothed before the residual is added. For residual coding, the encoder can select between a regular rectangular DCT for the whole block and a Shape Adaptive DCT for each region.

In some implementations, a quadtree plus binary decision tree (QTBT) can be implemented. In QTBT, at the Coding Tree Unit level, the partition parameters of QTBT are dynamically derived to adapt to the local characteristics without transmitting any overhead. Subsequently, at the Coding Unit (CU) level, a joint-classifier decision tree structure can eliminate unnecessary iterations and control the risk of false prediction. In some implementations, exponential partitioning can be available as an additional partitioning option available at every leaf node of the QTBT. In some implementations, exponential partitioning is available as an additional coding tool on the CU level of QTBT partitioning. For example, FIG. 8 illustrates an example of QTBT partitioning of a frame, and FIG. 9 illustrates an example of exponential partitioning at the CU level of the QTBT illustrated in FIG. 8.

In some implementations, a decoder includes an exponential partitioning processor that generates the exponential partitioning for the current block and provides all partition-related information for dependent processes. The exponential partitioning processor can directly influence motion compensation as it can be performed segment-wise in case a block is exponentially partitioned. Further, the partition processor can provide shape information to the intra-prediction processor and the transform coding processor.

In some implementations, additional syntax elements can be signaled at different hierarchy levels of the bitstream. For enabling exponential partitioning for an entire sequence, an enable flag can be coded in a Sequence Parameter Set (SPS). Further, a CTU flag can be coded at the coding tree unit (CTU) level to indicate whether any coding units (CU) use exponential partitioning. A CU flag can be coded to indicate whether the current coding unit utilizes exponential partitioning. The parameters which specify the curved line on the block can be coded. For each region, a flag can be decoded, which specifies whether the current region is inter- or intra-predicted.

In some implementations, a minimum region size can be specified.

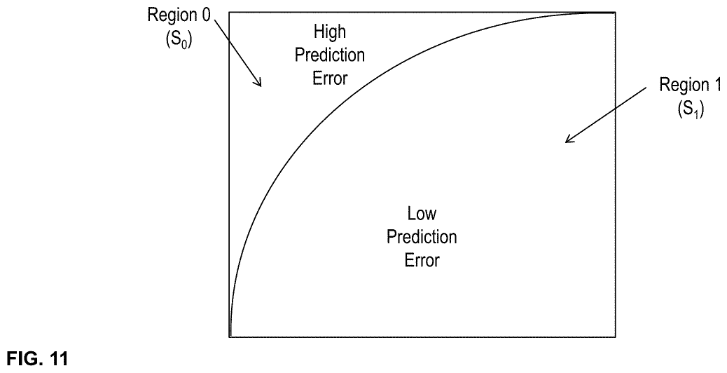

Referring now to FIG. 11, a diagram illustrating another example block 1100 partitioned according to exponential partitioning is presented. Because exponential partitioning will likely be utilized for blocks (e.g., coding units) containing objects with curved object boundaries, it is likely that the partitioning will result in one region having low prediction error, and another region having high prediction error. For example, as illustrated in FIG. 11, a block is partitioned with a curve, according to exponential partitioning. Assuming the luma samples within the block represent a ball and background, the two regions (S0 and S1) will include luma samples corresponding to the background and the ball, respectively. As a result, region S0 will have a high prediction error because region S0 relates to the background whereas region S1 will have low prediction error because region S1 relates to the ball. Accordingly, some aspects of the current subject matter can include performing the SADCT for the region having low prediction error. By performing the SADCT for the region having low prediction error, instead of full block DCT, compression efficiency can be improved.

In some implementations, during decoding, parameters for performing inverse SADCT can be inferred from exponential partitioning parameters. For example, a transform size can be determined from an exponential partitioning template index.

In some implementations, the SADCT can be implemented for blocks of size 64×64 and/or 128×128. In some implementations, the SADCT can be signaled as an additional transform choice to full block DCT for the segment with low prediction error.

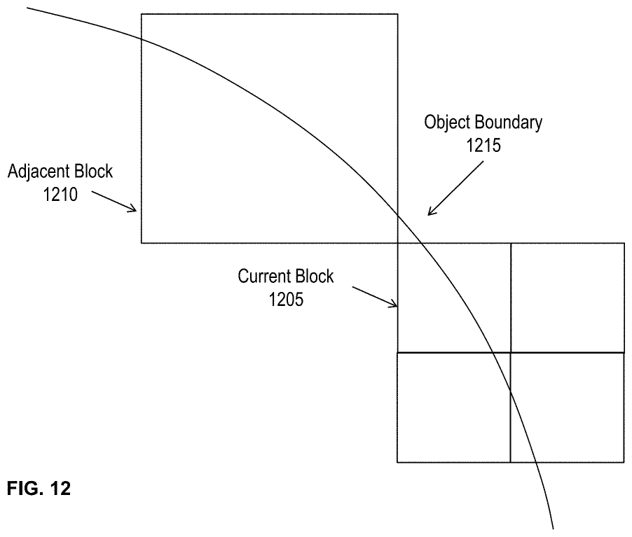

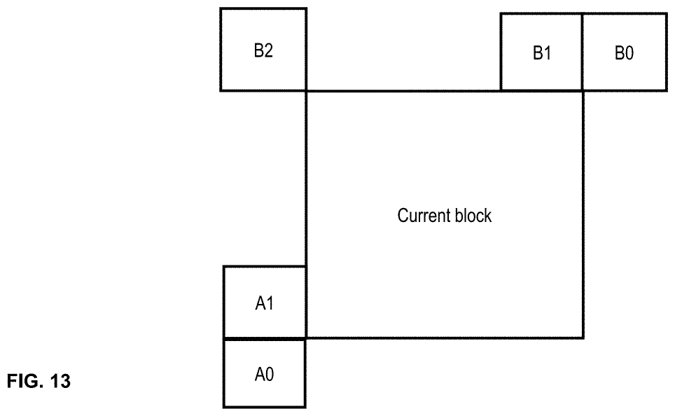

Referring now to FIG. 12, a diagram illustrating inheritance of exponential partitioning parameters by a current block 1205 from a spatially adjacent block 1210 is presented. The curve indicates an object boundary 1215 in an image. Current block 1205 and spatially adjacent block 1210 indicate coding unit or prediction unit blocks in a quad-tree plus binary tree (QTBT). As illustrated, the object boundary 1215 generally includes a relatively uniform curvature. Both adjacent block 1210 and current block 1205 would be partitioned using exponential partitioning. Using some implementations of the current subject matter, rather than sending all exponential partitioning parameters (e.g., indices to shape and/or orientation templates, coefficients, start indices, end indices, and/or the like), an exponential partitioning merge can be signaled in the bitstream along with an index to the adjacent block 1210. During decoding of the current block, the current block can inherit some or all of the exponential partitioning parameters from the indicated adjacent block. FIG. 13 illustrates examples of spatially adjacent blocks for a current block. The spatially adjacent blocks can include blocks (e.g., coding units or prediction units) that reside at the same location as (e.g., overlap with) A0 (below-left), A1 (left), B0 (above-right), B1 (above), and B2 (above-left).

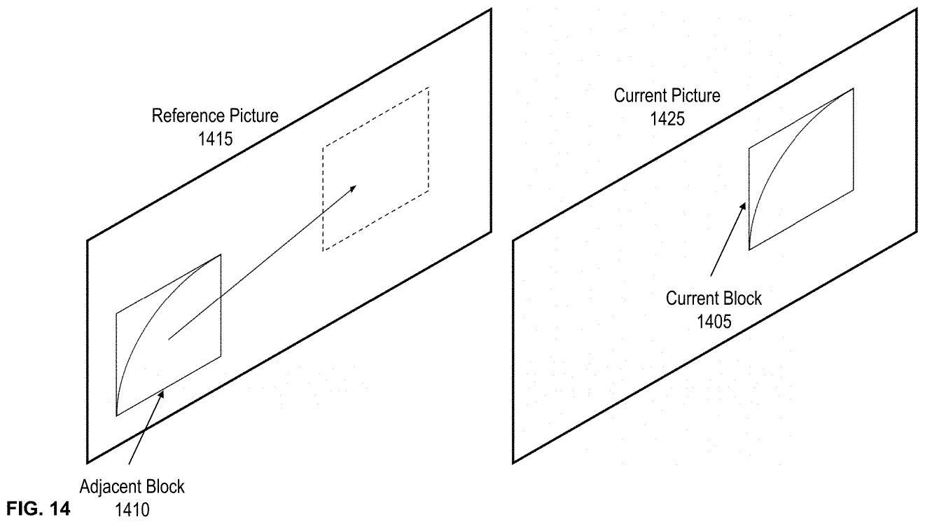

In addition, the adjacent block from which a given current block inherits exponential partitioning parameters can be temporally adjacent. FIG. 14 illustrates an example current block 1405 with a temporally adjacent block 1410 from which the current block 1405 inherits exponential partitioning parameters. As illustrated in FIG. 14, a reference picture 1415 includes the adjacent block 1410, which has an associated motion vector 1420, characterizing motion of the adjacent block 1410 from the reference picture 1415 to the current picture 1425, which contains the current block 1405. Using some implementations of the current subject matter, rather than sending all exponential partitioning parameters (e.g., indices to shape and/or orientation templates, coefficients, and/or the like), an exponential partitioning merge can be signaled in the bitstream along with an index to the adjacent block 1410. During decoding of the current block 1405, the current block 1405 can inherit some or all of the exponential partitioning parameters from the indicated adjacent block 1410.

In some implementations, the parent block need not be an adjacent block, for example, can be another block in the current frame that has been previously decoded.

In some implementations, a current block can inherit only some exponential partitioning parameters from another block. For example, a current block can inherit a first parameter (e.g., a shape template) from a first parent block, and additional parameters (e.g., start point, end point, orientation template, and the like) can be included in the bitstream.

The subject matter described herein provides many technical advantages. For example, some implementations of the current subject matter can provide for partitioning of blocks that increases compression efficiency. In some implementations, by implementing partitioning in a manner that more closely follows object boundaries, effective visual effects can be achieved. Similarly, in some implementations, by implementing partitioning in a manner that more closely follows object boundaries, blocking artifacts at object boundaries can be reduced. In some implementations, by implementing SADCT as an additional transform choice to full block DCT and applying SADCT to exponentially partitioned regions that have low prediction error, compression efficiency can be increased, and complexity can be reduced.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub combinations of the disclosed features and/or combinations and sub combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A decoder, the decoder comprising circuitry configured to:
receive a bitstream including a coded picture;
identify a non-straight, non-rectangular boundary in the coded picture, the non-straight, non-rectangular boundary having a first side and a second side;
generate a first predictor for use on the first side;
generate a second predictor for use on the second side;
smooth the first predictor and the second predictor across the non-straight, non-rectangular boundary;
add residual pixel values to each of the first predictor and the second predictor; and
decode the coded picture using the first predictor, the second predictor, and the residual pixel values.

2. The decoder of claim 1, wherein the non-straight, non-rectangular boundary further comprises a curve.

3. The decoder of claim 2, wherein the curve further comprises an exponential curve.

4. The decoder of claim 1, wherein the non-straight, non-rectangular boundary is characterized by a predefined template.

5. The decoder of claim 1, wherein the first predictor utilizes a first motion vector.

6. The decoder of claim 1, wherein the second predictor utilizes a second motion vector.

7. The decoder of claim 1 wherein:
the picture depicts a curved object; and
the non-straight, non-rectangular boundary represents a boundary of the curved object.

8. The decoder of claim 1, further comprising:
an entropy decoder processor configured to receive the bitstream and decode the bitstream into quantized coefficients;
an inverse quantization and inverse transformation processor configured to process the quantized coefficients including performing an inverse discrete cosine transform;
a deblocking filter;
a frame buffer; and
an intra prediction processor.

9. The decoder of claim 1, wherein at least one of the first side and the second side includes a coding tree unit

10. The decoder of claim 1, wherein at least one of the first side and the second side includes a coding unit.

11. A method, the method comprising:
receiving, by a decoder, a bitstream including a coded picture;
identifying, by the decoder, a non-straight, non-rectangular boundary in the coded picture, the non-straight, non-rectangular boundary having a first side and a second side;
generating, by the decoder, a first predictor for use on the first side;
generating, by the decoder, a second predictor for use on the second side;
smoothing, by the decoder, the first predictor and the second predictor across the non-straight, non-rectangular boundary;
adding, by the decoder, residual pixel values to each of the first predictor and the second predictor; and
decoding, by the decoder, the coded picture using the first predictor, the second predictor, and the residual pixel values.

12. The method of claim 11, wherein the non-straight, non-rectangular boundary further comprises a curve.

13. The method of claim 12, wherein the curve further comprises an exponential curve.

14. The method of claim 11, wherein the non-straight, non-rectangular boundary is characterized by a predefined template.

15. The method of claim 11, wherein:
the coded picture depicts a curved object; and
the non-straight, non-rectangular boundary represents a boundary of the curved object.

16. The method of claim 11 wherein the first predictor further comprises a first motion vector.

17. The method of claim 11, wherein the second predictor further comprises a second motion vector.

18. The method of claim 11, wherein the decoder further comprises:
an entropy decoder processor configured to receive the bitstream and decode the bitstream into quantized coefficients;
an inverse quantization and inverse transformation processor configured to process the quantized coefficients including performing an inverse discrete cosine transform;
a deblocking filter;
a frame buffer; and
an intra prediction processor.

19. The method of claim 11, wherein at least one of the first side and the second side includes a coding tree unit

20. The method of claim 11, wherein at least one of the first side and the second side includes coding unit.
